(19) United States
(12) Patent Application Publication
(10) Pub. No.: US 2024/0400235 A1
(43) Pub. Date: Dec. 5, 2024

(54) FLYING OBJECT TRACKING METHOD, FLYING OBJECT TRACKING SYSTEM, SATELLITE CONSTELLATION, AND GROUND SYSTEM

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 18/699,404

(22) PCT Filed: Oct. 13, 2021
(86) PCT No.: PCT/JP2021/037802

§ 371 Date: Apr. 8, 2024

(51) Int. Cl. B64G 3/00; B64G 1/10

(52) U.S. Cl. CPC B64G 3/00; B64G 1/1085

(57) ABSTRACT

A detecting satellite in a satellite constellation detects a launch of a flying object and transmits, via communications with artificial satellites ahead and behind it on a detecting orbital plane, launch detection information to each artificial satellite on the detecting orbital plane. A source satellite on the detecting orbital plane transmits the launch detection information to a target satellite on a via-orbital plane that passes above a ground system. The target satellite transmits the launch detection information to each artificial satellite on the via-orbital plane via communications with artificial satellites ahead and behind it on the via-orbital plane. An air-to-ground satellite on the via-orbital plane transmits the launch detection information to the ground system.

### TECHNICAL FIELD

The present disclosure relates to tracking of a flying object by a satellite constellation.

### BACKGROUND ART

For monitoring of flying objects as threats, GEO satellites monitoring for plume from geostationary orbits have been effective. However, the emergence of flying objects that intermittently repeat injection has necessitated tracking at post-boost phase, giving rise to the issue of GEO satellites losing their effectiveness. GEO is an abbreviation for Geostationary Orbit.

In the United States, an idea of a launch detection/tracking system based on LEO constellation is under study. However, it requires hundreds of artificial satellites and has a challenge in terms of cost scale. LEO is an abbreviation for Low Earth Orbit.

In an LEO, coordination between a monitoring constellation and a communication constellation is essential. However, one challenge is complexity of communication operations involved for exchange of information between LEO satellites, which change their flying positions with time.

At the time of launch detection, landing prediction is not possible because the flight direction of the flying object is unknown. Accordingly, it is necessary to predict its flight path through tracking and monitoring. However, a challenge is that selection of artificial satellites to continuously perform monitoring is difficult and transmission of flying object information is difficult.

In order to establish a communication line twice in each revolution in optical communication, technology for accurate optical axis alignment needs to be established. Another challenge is significant loss time.

An LEO satellite passes over a certain ground facility in a short time. Additionally, rotation of its orbital plane is not in synchronization with the rotation of the earth. Further, transmission of flying object information to a specific ground facility or a specific countering asset requires settings of route search for communication paths, selection of artificial satellites through which the information is to be routed, and times of exchange of the information. That is, there is a challenge of complicated operation.

Patent Literature 1 discloses monitoring satellites for thoroughly monitoring regions at a certain latitude with a small number of satellites flying in low orbits.

### CITATION LIST

### Patent Literature

Patent Literature 1: JP 4946398

### SUMMARY OF INVENTION

### Technical Problem

An object of the present disclosure is to enable tracking of a flying object even if the flying object intermittently repeats injection.

### Solution to Problem

A flying object tracking method according to the present disclosure is a method with a flying object tracking system that includes a ground system and a satellite constellation.

The satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane,
a detecting satellite detects a launch of a flying object and transmits, via communications with the artificial satellites ahead and behind it on a detecting orbital plane, launch detection information to each of artificial satellites on the detecting orbital plane, wherein the detecting satellite is one of the artificial satellites in the satellite constellation and the detecting orbital plane is the own orbital plane,
when a source satellite flies on the detecting orbital plane in a communication range with a via-orbital plane that passes above the ground system, the source satellite transmits the launch detection information to a target satellite, wherein the source satellite is one of the artificial satellites on the detecting orbital plane and the target satellite is one of the artificial satellites on the via-orbital plane,
the target satellite transmits the launch detection information to each of the artificial satellites on the via-orbital plane via communications with the artificial satellites ahead and behind it on the via-orbital plane, and
an air-to-ground satellite transmits the launch detection information to the ground system, wherein the air-to-ground satellite is one of the artificial satellites on the via-orbital plane.

### Advantageous Effects of Invention

According to the present disclosure, it is possible to track a flying object even if the flying object intermittently repeats injection.

### BRIEF DESCRIPTION OF DRAWINGS

FIG. 1 shows a configuration of a flying object tracking system 100 in Embodiment 1.

FIG. 2 shows a configuration of an artificial satellite 220 in Embodiment 1.

FIG. 3 shows a procedure of operations of the flying object tracking system 100 in Embodiment 1.

FIG. 4 shows a procedure of operations of the flying object tracking system 100 in Embodiment 1.

FIG. 5 illustrates feature (1) in Embodiment 1.

FIG. 6 shows information in a flight path model 119 in Embodiment 1.

FIG. 7 shows information in the flight path model 119 in Embodiment 1.

FIG. 8 shows information in the flight path model 119 in Embodiment 1.

FIG. 9 illustrates feature (3) in Embodiment 1.

FIG. 10 illustrates feature (4) in Embodiment 1.

FIG. 11 illustrates feature (5) in Embodiment 1.

FIG. 12 shows how communication is performed between satellites ahead and behind each other on the same orbital plane.

FIG. 13 shows how communication is performed between right and left satellites in adjacent orbits.

FIG. 14 illustrates switching of right and left sides between artificial satellites in adjacent orbits at southern and northern edges.

FIG. 15 shows how communication is performed between orbital planes in Embodiment 1.

FIG. 16 shows a flow of communication to a ground system in Embodiment 1.

FIG. 17 shows field of view ranges of artificial satellites in an equatorial orbit.

FIG. 18 shows how limb observation is performed from approximately above the equator.

FIG. 19 shows field of view ranges of artificial satellites in an inclined orbit.

FIG. 20 shows how limb observation is performed from different latitude zones.

FIG. 21 shows how a solid angle is guaranteed in a mid-latitude zone.

FIG. 22 shows how a solid angle is guaranteed in a mid-latitude zone.

### DESCRIPTION OF EMBODIMENTS

In an embodiment and drawings, the same or corresponding elements are denoted with the same reference characters. Description of elements with the same reference characters as already described elements are omitted or simplified as appropriate.

### Embodiment 1

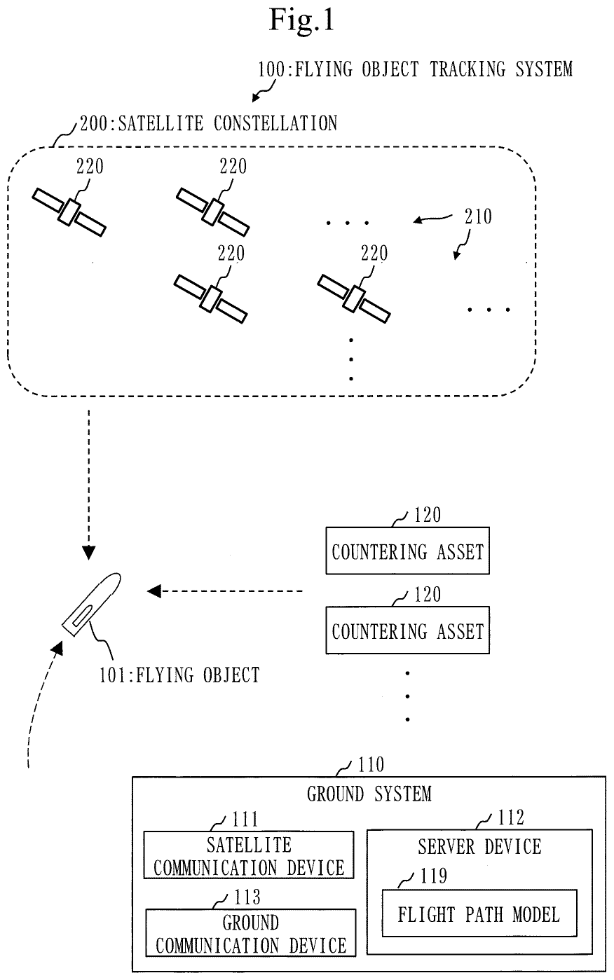

A flying object tracking system 100 is described based on FIGS. 1 to 22.

### ***Description of Configuration***

Based on FIG. 1, the configuration of the flying object tracking system 100 is described.

The flying object tracking system 100 is a system to monitor a flying object 101 while tracking it.

The flying object tracking system 100 includes a satellite constellation 200, a ground system 110, and multiple countering assets 120.

The satellite constellation 200 forms multiple orbital planes. Specifically, the satellite constellation 200 forms 12 or more orbital planes.

The multiple orbital planes are such that azimuth components of their normal vectors are distributed in a longitude direction relative to each other.

The satellite constellation 200 includes multiple artificial satellite groups 210. Specifically, the satellite constellation 200 includes 12 or more artificial satellite groups 210.

The multiple artificial satellite groups 210 fly on different orbital planes from each other. The orbital plane of each artificial satellite group 210 is referred to as “own orbital plane”.

Each artificial satellite group 210 is made up of multiple artificial satellites 220. Specifically, each artificial satellite group 210 is made up of 15 or more artificial satellites 220.

The multiple artificial satellites 220 fly in an inclined orbit of the own orbital plane.

The ground system 110 includes a satellite communication device 111, a server device 112, and a ground communication device 113.

The satellite communication device 111 is a communication device for communicating with the individual artificial satellites 220. Communications with individual artificial satellites 220 are carried out using the satellite communication device 111.

The server device 112 is a computer equipped with a processing circuit. A storage unit in the server device 112 stores a flight path model 119 and the like. The flight path model 119 will be discussed later.

The ground communication device 113 is a communication device for communicating with the individual countering assets 120. Communications with individual countering assets 120 are carried out using the ground communication device 113.

The multiple countering assets 120 are deployed at different locations from each other in order to counter the flying object 101.

Specific examples of the countering assets 120 are vehicles deployed on land, ships deployed in seas, and airplanes deployed in air.

The processing circuitry is described.

The processing circuitry may be dedicated hardware or a processor that executes programs stored in memory.

In the processing circuitry, some of functions may be implemented by dedicated hardware and the remaining functions may be implemented by software or firmware. That is, the processing circuitry can be implemented by hardware, software, firmware, or a combination of them.

Dedicated hardware is, for example, a single circuit, a composite circuit, a programmed processor, a parallel-programmed processor, an ASIC, an FPGA, or a combination of them.

ASIC is an abbreviation for Application Specific Integrated Circuit.

FPGA is an abbreviation for Field Programmable Gate Array.

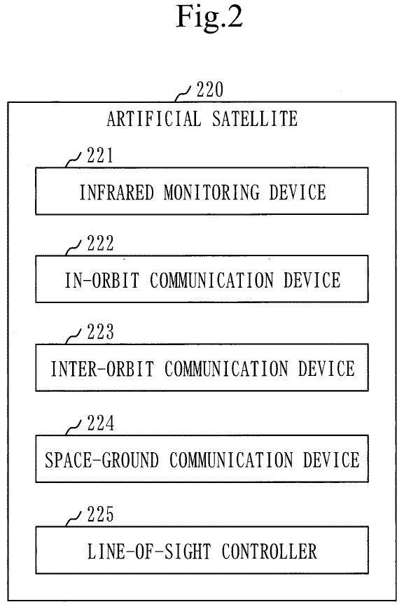

Based on FIG. 2, the configuration of the artificial satellites 220 is described.

Each artificial satellite 220 includes an infrared monitoring device 221, an in-orbit communication device 222, an inter-orbit communication device 223, a space-ground communication device 224, and a line-of-sight controller 225.

The orbital plane of an artificial satellite 220 that communicates on an orbital plane different from the own orbital plane with an artificial satellite 220 of the own orbital plane is referred to as an “orbital plane of interest”.

The infrared monitoring device 221 is a monitoring device using infrared. Specifically, the infrared monitoring device 221 is pointed to a limb of the earth in monitoring of the flying object 101.

The in-orbit communication device 222 is a communication device for communicating with artificial satellites 220 ahead and behind on the own orbital plane. Specifically, the in-orbit communication device 222 is a communication device pointed in a fore-and-aft direction of the flight direction. By communications in the artificial satellite group 210 on the own orbital plane, an annular communication network is formed on the own orbital plane. Communications with the artificial satellites 220 ahead and behind on the own orbit are carried out using the in-orbit communication device 222.

The inter-orbit communication device 223 is a communication device for communicating with the artificial satellites 220 on the orbital plane of interest. Specifically, inter-orbit communication device 223 is a communication device to perform proximity communication. Communications with the artificial satellites 220 on the orbital plane of interest are carried out using the inter-orbit communication device 223.

The space-ground communication device 224 is a communication device for communicating with the ground system 110 and the countering assets 120. Communications with the ground system 110 and with the countering assets 120 are carried out using the space-ground communication device 224.

The line-of-sight controller 225 is a piece of hardware for controlling the direction of line of sight in monitoring by the infrared monitoring device 221.

Specific examples of the line-of-sight controller 225 are an attitude control device, a pointing mechanism, or a combination thereof.

The attitude control device controls attitude elements, such as an attitude of the artificial satellite 220 and an angular speed of the artificial satellite 220. Specifically, the attitude control device changes each attitude element in a desired direction. Alternatively, the attitude control device maintains each attitude element in a desired direction. The attitude control device includes an attitude sensor, an actuator, and a controller. The controller corresponds to the processing circuitry. The attitude sensor can be a gyroscope, an earth sensor, a sun sensor, a star tracker, a thruster, a magnetic sensor, or the like. The actuator can be an attitude control thruster, a momentum wheel, a reaction wheel, a control moment gyro, or the like. The controller controls the actuator in accordance with measurement data of the attitude sensor or various commands from the ground system 110.

The pointing mechanism changes the direction of line of sight of the infrared monitoring device 221. The pointing mechanism can be a driver mirror, for example.

### ***Description of Operation***

A method performed by the flying object tracking system 100 is referred to as a flying object tracking method.

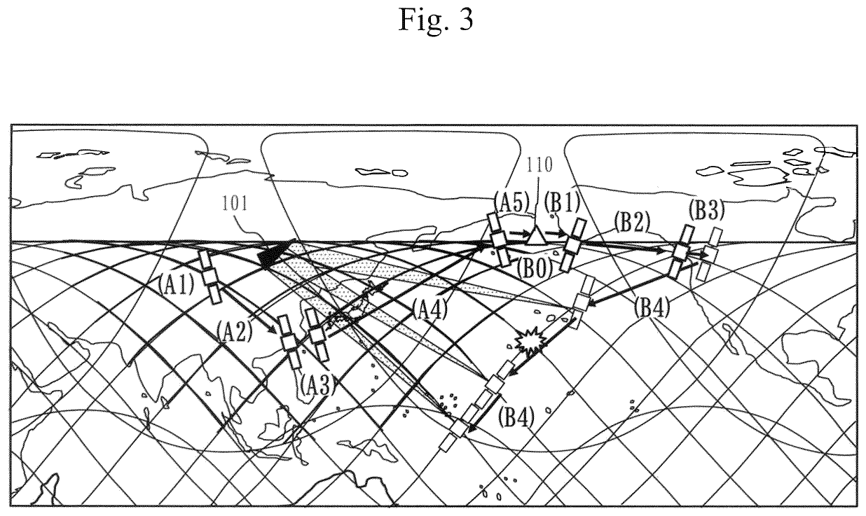

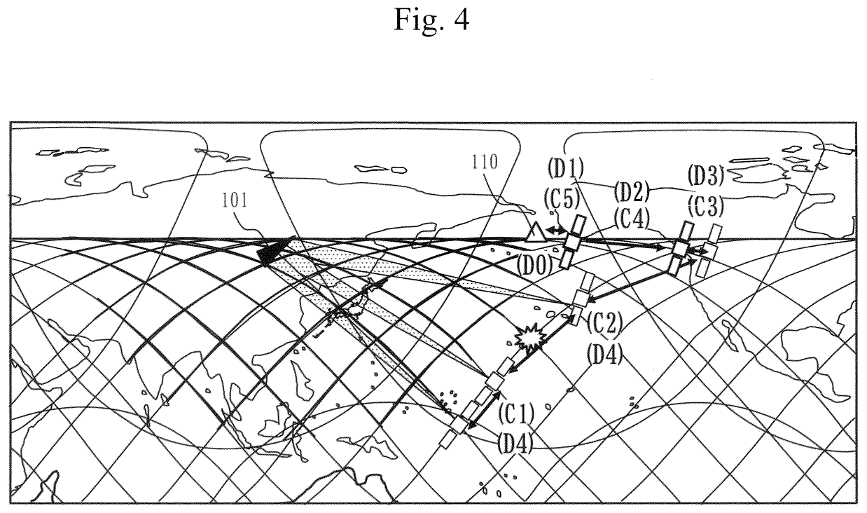

Based on FIGS. 3 and 4, the flying object tracking method is described.

Based on FIG. 3, a procedure (A1) to (A5) of transmitting launch detection information from an artificial satellite 220 that has detected the launch of the flying object 101 to the ground system 110 is described.

(A1) On at least any of the artificial satellites 220, the infrared monitoring device 221 detects the launch of the flying object 101 and generates launch detection information.

The launch detection information indicates the time of launch of the flying object 101 and coordinate values of the launch point of the flying object 101. An intersection point of the direction of line of sight from the artificial satellite 220 at the time of launch and the ground surface represents the launch point.

Each artificial satellite 220 that has detected the launch of the flying object 101 is referred to as a “detecting satellite”.

The orbital plane of the detecting satellite is referred to as a “detecting orbital plane”.

(A2) The detecting satellite transmits the launch detection information to the artificial satellites 220 ahead and behind it on the detecting orbital plane. Each of the artificial satellites 220 to which the launch detection information is transmitted receives the launch detection information and transmits the launch detection information to the artificial satellites 220 ahead and behind it. As a result, the launch detection information is shared in the artificial satellite group 210 on the detecting orbital plane.

On each of two orbital planes, a range in which inter-satellite communication with the artificial satellites 220 on the other orbital plane is possible is referred to as “inter-orbital plane communication range”. Specifically, the inter-orbital plane communication range is a closest approach point between the orbital planes and the vicinity of the closest approach point. A closest approach point between orbital planes is a point that is closest to the other orbital plane. Two closest approach points are formed on the intersection line of two orbital planes.

An orbital plane that passes above the ground system 110 is referred to as a “via-orbital plane A”.

An artificial satellite 220 that flies on the detecting orbital plane in the inter-orbital plane communication range with the via-orbital plane A is referred to as a “source satellite A”.

An artificial satellite 220 that flies on the via-orbital plane A in the inter-orbital plane communication range with the detecting orbital plane when the source satellite A is flying on the detecting orbital plane in the inter-orbital plane communication range with the via-orbital plane A is referred to as a “target satellite A”.

(A3) When the source satellite A flies on the detecting orbital plane in the inter-orbital plane communication range with the via-orbital plane A, the source satellite A transmits the launch detection information to the target satellite A on the via-orbital plane A. The target satellite A receives the launch detection information. As a result, the annular communication network of the detecting orbital plane is connected with the annular communication network of the via-orbital plane.

(A4) The target satellite A transmits the launch detection information to the artificial satellites 220 ahead and behind it on the via-orbital plane A. Each of the artificial satellites 220 to which the launch detection information is transmitted receives the launch detection information and transmits the launch detection information to the artificial satellites 220 ahead and behind it. As a result, the launch detection information is shared in the artificial satellite group 210 on the via-orbital plane A.

An artificial satellite 220 that flies above the ground system 110 on the via-orbital plane A is referred to as an “air-to-ground satellite A”.

(A5) The air-to-ground satellite A transmits the launch detection information to the ground system 110. The satellite communication device 111 receives the launch detection information.

Based on FIG. 3, a procedure (B0) to (B4) of transmitting a monitor command from the ground system 110 to artificial satellites 220 which are to monitor the flying object 101 is described.

(B0) The server device 112 derives a predicted time of landing of the flying object 101 and the coordinate values of a predicted point of landing of the flying object 101 based on the launch detection information and the flight path model 119. “Deriving” is equivalent to “calculating”.

The flight path model 119 is data representing the flight path of a model flying object.

The flight path model 119 includes a flight profile.

The flight profile represents a flight path by indicating a relationship between flight direction, time-series flight distance, and time-series flight altitude.

The time-series flight distance is the distance flown at each path time since the launch.

The time-series flight altitude is the flight altitude at each elapsed time since the launch.

An orbital plane that will pass above the predicted point of landing at the predicted time of landing is referred to as a “monitoring orbital plane”.

The server device 112 selects the monitoring orbital plane.

The server device 112 generates a monitor command for each artificial satellite 220 on the monitoring orbital plane.

Specifically, the monitor command is a command to order them to point above the launch point in monitoring the flying object 101. The monitor command indicates the coordinate values of the launch point.

A time when transmission preparation for the monitor command is completed is referred to as “preparation completion time B”.

An orbital plane that passes above the ground system 110 at the preparation completion time B is referred to as a “via-orbital plane B”.

The server device 112 selects the via-orbital plane B.

An artificial satellite 220 that flies above the ground system 110 on the via-orbital plane B is referred to as an “air-to-ground satellite B”.

(B1) The satellite communication device 111 transmits the monitor command to the air-to-ground satellite B on the via-orbital plane B. The air-to-ground satellite B receives the monitor command.

(B2) The air-to-ground satellite B transmits the monitor command to the artificial satellites 220 ahead and behind it on the via-orbital plane B. Each of the artificial satellites 220 to which the monitor command is transmitted receives the monitor command and transmits the monitor command to the artificial satellites 220 ahead and behind it. As a result, the monitor command is shared in the artificial satellite group 210 on the via-orbital plane B.

An artificial satellite 220 that flies on the via-orbital plane B in the inter-orbital plane communication range with the monitoring orbital plane is referred to as a “source satellite B”.

An artificial satellite 220 that flies on the monitoring orbital plane in the inter-orbital plane communication range with the via-orbital plane B when the source satellite B is flying on the via-orbital plane B in the inter-orbital plane communication range with the monitoring orbital plane is referred to as a “target satellite B”.

(B3) When the source satellite B flies on the via-orbital plane B in the inter-orbital plane communication range with the monitoring orbital plane, the source satellite B transmits the monitor command to the target satellite B on the monitoring orbital plane. The target satellite B receives the monitor command. As a result, the annular communication network of the via-orbital plane B is connected with the annular communication network of the monitoring orbital plane.

(B4) The target satellite B transmits the monitor command to the artificial satellites 220 ahead and behind it on the monitoring orbital plane. Each of the artificial satellites 220 to which the monitor command is transmitted receives the monitor command and transmits the monitor command to the artificial satellites 220 ahead and behind it. As a result, the monitor command is shared in the artificial satellite group 210 on the monitoring orbital plane.

Each artificial satellite 220 on the monitoring orbital plane executes monitoring of the flying object 101 in accordance with the monitor command.

Based on FIG. 4, a procedure (C1) to (C4) of transmitting flying object information from an artificial satellite 220 that has monitored the flying object 101 to the ground system 110 is described.

(C1) On at least any of the artificial satellites 220 on the monitoring orbital plane, the infrared monitoring device 221 monitors the flying object 101 and generates flying object information.

The flying object information indicates the time of flight of the flying object 101 and the coordinate values of a flight point of the flying object 101.

Each artificial satellite 220 that has monitored the flying object 101 is referred to as a “monitoring satellite”.

(C2) The monitoring satellite transmits the flying object information to the artificial satellites 220 ahead and behind it on the monitoring orbital plane. Each of the artificial satellites 220 to which the flying object information is transmitted receives the flying object information and transmits the flying object information to the artificial satellites 220 ahead and behind it. As a result, the flying object information is shared in the annular communication network of the monitoring orbital plane.

An orbital plane that passes above the ground system 110 is referred to as a “via-orbital plane C”.

An artificial satellite 220 that flies on the monitoring orbital plane in the inter-orbital plane communication range with the via-orbital plane C is referred to as a “source satellite C”.

An artificial satellite 220 that flies on the via-orbital plane C in the inter-orbital plane communication range with the monitoring orbital plane when the source satellite C is flying on the monitoring orbital plane in the inter-orbital plane communication range with the via-orbital plane C is referred to as a “target satellite C”.

(C3) When the source satellite C flies on the monitoring orbital plane in the inter-orbital plane communication range with the via-orbital plane C, the source satellite C transmits the flying object information to the target satellite C on the via-orbital plane C. The target satellite C receives the flying object information. As a result, the annular communication network of the monitoring orbital plane is connected with the annular communication network of the via-orbital plane C.

(C4) The target satellite C transmits the flying object information to the artificial satellites 220 ahead and behind it on the via-orbital plane C. Each of the artificial satellites 220 to which the flying object information is transmitted receives the flying object information and transmits the flying object information to the artificial satellites 220 ahead and behind it. As a result, the flying object information is shared in the artificial satellite group 210 on the via-orbital plane C.

An artificial satellite 220 that flies above the ground system 110 on the via-orbital plane C is referred to as an “air-to-ground satellite C”.

(C5) The air-to-ground satellite C transmits the flying object information to the ground system 110. The satellite communication device 111 receives the flying object information.

Based on FIG. 4, a procedure (D0) to (D4) of transmitting a track command from the ground system 110 to artificial satellites 220 which are to monitor the flying object 101 and transmitting a counter command from the ground system 110 to the countering asset 120 which is to counter the flying object 101 is described.

(D0) The server device 112 derives the predicted time of landing, the coordinate values of the predicted point of landing, and the predicted flight path based on the flying object information and the flight path model 119.

The predicted flight path is indicated by the coordinate values of the predicted flight point at each time until the predicted time of landing.

An orbital plane that will pass above the predicted point of landing at the predicted time of landing is referred to as a “tracking orbital plane”.

The server device 112 selects the tracking orbital plane.

The server device 112 generates a track command for each artificial satellite 220 on the tracking orbital plane.

Specifically, the track command is a command to order them to point to the flight point at each time in monitoring the flying object 101. The track command indicates the predicted flight path.

The server device 112 generates a counter command for countering assets 120. Specifically, the counter command is a command to order them to counter the flying object 101. The counter command indicates the flying object information.

A time when transmission preparation for the track command and the counter command is completed is referred to as “preparation completion time D”.

An orbital plane that passes above the ground system 110 at the preparation completion time D is referred to as a “via-orbital plane D”.

The server device 112 selects the via-orbital plane D.

An artificial satellite 220 that flies above the ground system 110 on the via-orbital plane D is referred to as an “air-to-ground satellite D”.

(D1) The satellite communication device 111 transmits the track command and the counter command to the air-to-ground satellite D on the via-orbital plane D. The air-to-ground satellite D receives the track command and the counter command.

(D2) The air-to-ground satellite D transmits the track command and the counter command to the artificial satellites 220 ahead and behind it on the via-orbital plane D. Each of the artificial satellites 220 to which the track command and the counter command are transmitted receives the track command and the counter command and transmits the track command and the counter command to the artificial satellites 220 ahead and behind it. As a result, the track command and the counter command are shared in the artificial satellite group 210 on the via-orbital plane D.

An artificial satellite 220 that flies on the via-orbital plane D in the inter-orbital plane communication range with the tracking orbital plane is referred to as a “source satellite D”.

An artificial satellite 220 that flies on the tracking orbital plane in the inter-orbital plane communication range with the via-orbital plane D when the source satellite D is flying on the via-orbital plane D in the inter-orbital plane communication range with the tracking orbital plane is referred to as a “target satellite D”.

(D3) When the source satellite D flies on the via-orbital plane D in the inter-orbital plane communication range with the tracking orbital plane, the source satellite D transmits the track command and the counter command to the target satellite D on the tracking orbital plane. The target satellite D receives the track command and the counter command. As a result, the annular communication network of the via-orbital plane D is connected with the annular communication network of the tracking orbital plane.

(D4) The target satellite D transmits the track command and the counter command to the artificial satellites 220 ahead and behind it on the tracking orbital plane. Each of the artificial satellites 220 to which the track command and the counter command are transmitted receives the track command and the counter command and transmits the track command and the counter command to the artificial satellites 220 ahead and behind it. As a result, the track command and the counter command are shared in the artificial satellite group 210 on the tracking orbital plane.

Each artificial satellite 220 on the tracking orbital plane executes monitoring of the flying object 101 in accordance with the track command.

At least any of the artificial satellites 220 on the tracking orbital plane transmits the counter command to at least any countering asset 120.

Each countering asset 120 receives the counter command and performs countering of the flying object 101 in accordance with the counter command.

### Features of Embodiment 1

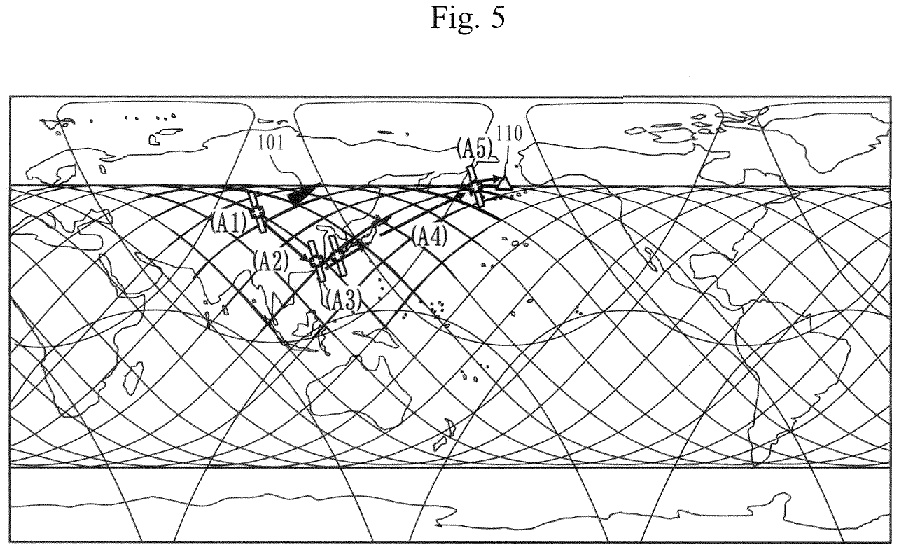

Based on FIG. 5, feature (1) of Embodiment 1 is described.

The flying object tracking system (100) is formed of the satellite constellation (200) and the ground system (110), and transmits launch detection information for the flying object (101) to the ground system.

In the satellite constellation, each of multiple artificial satellites (220) flies in an inclined orbit. Each of the multiple artificial satellites includes the infrared monitoring device (221), the first communication device (222), and the second communication device (224). The first communication device communicates with the artificial satellites ahead and behind on the same orbital plane. The second communication device communicates with the ground system. The multiple artificial satellites form an annular communication network with the artificial satellites ahead and behind them on the same orbital plane.

The satellite constellation includes multiple orbital planes with the azimuth components of the normal vectors distributed in the longitude direction.

Each artificial satellite includes the third communication device (223). The third communication device communicates with artificial satellites in a different orbit when the artificial satellite passes near a closest approach point on its orbit. Two closest approach points are formed on the intersection line with the different orbital plane.

(A1, A2) An artificial satellite that has detected the launch of a flying object on a first orbital plane (a monitoring orbital plane) shares information with a first annular communication network. The first annular communication network is formed by the artificial satellite that has detected the launch of the flying object and the artificial satellites ahead and behind it on the same orbital plane.

(A3 to A5) Artificial satellites flying on a second orbital plane (a via-orbital plane), which passes above the ground system, share information via a second annular communication network and communicate with the ground system. The second annular communication network is formed on the second orbital plane.

The artificial satellites on the first orbital plane and the artificial satellites on the second orbital plane connect the first annular communication network with the second annular communication network by performing communication between the satellites when they pass near a closest approach point in their respective orbits. Then, the artificial satellites on the first orbital plane and the artificial satellites on the second orbital plane transmit launch detection information for the flying object to the ground system by way of the first annular communication network and the second annular communication network.

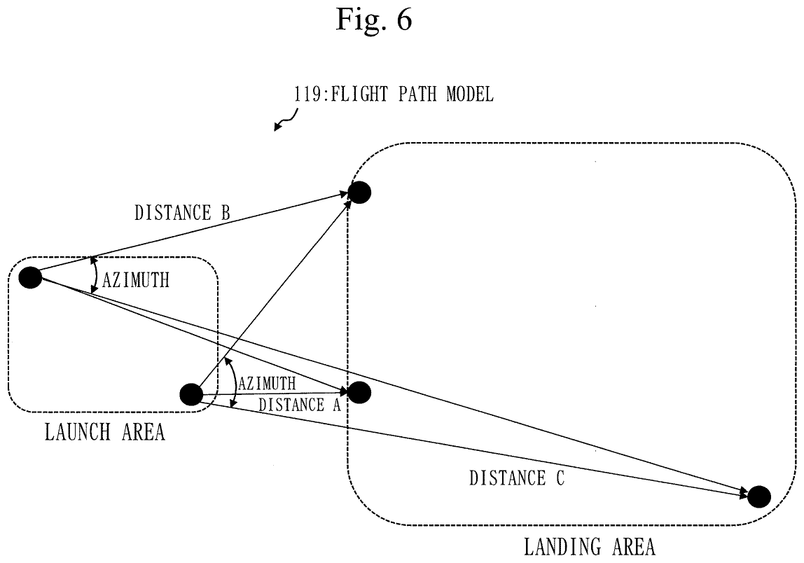

Based on FIGS. 6 to 8, feature (2) of Embodiment 1 is described.

The ground system includes the server (112).

The server generates and stores flight path models for multiple typical flying objects, respectively.

The flight path model is composed of flight duration, the position coordinates of a launch site, the position coordinates of the predicted point of landing, flight direction, time-series flight distance, and a flight altitude profile. The flight duration is the amount of time from the launch site to the predicted point of landing. The time-series flight distance is a time series of the distance from the launch of the flying object to its landing. The flight altitude profile is a time series of the altitude from the launch of the flying object to its landing.

The ground system receives the time of launch TO of the flying object and the position coordinates of the launch point as launch detection information. The ground system then derives a time Tn (the predicted time of landing) at which the flying object will arrive at the position coordinates (xn, yn, zn) of a predicted point of landing N in the flight path model.

FIG. 6 shows a relationship between a launch area, in which the launch point is included, and a landing area, in which the predicted point of landing is included. This relationship is indicated by the flight path model 119.

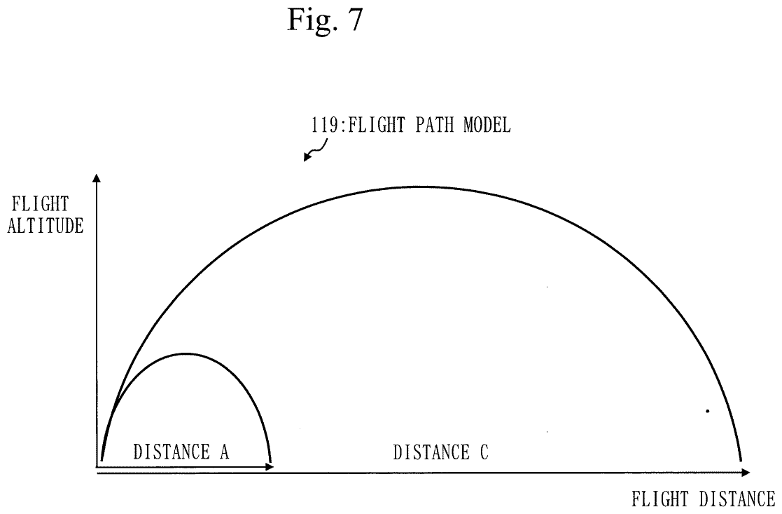

FIG. 7 shows a relationship between the flight distance and the flight altitude of flying objects that undergo a ballistic flight. This relationship is indicated by the flight path model 119.

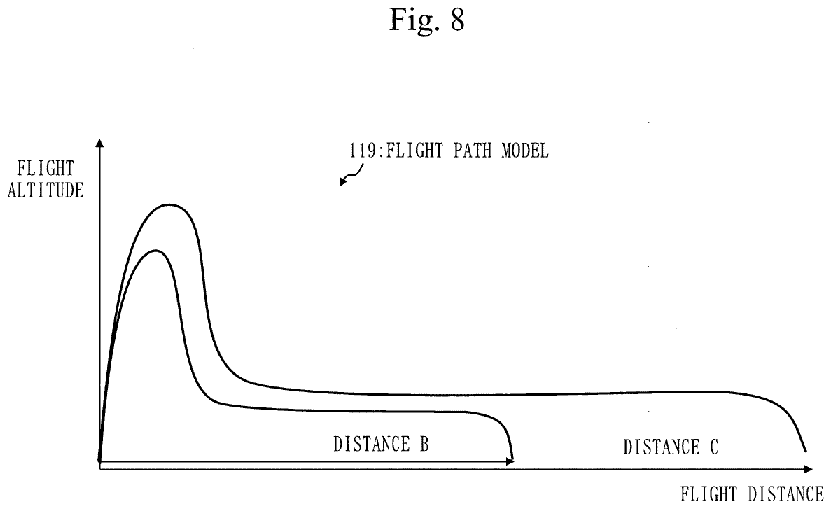

FIG. 8 shows a relationship between the flight distance and the flight altitude of flying objects that perform intermittent injection. This relationship is indicated by the flight path model 119.

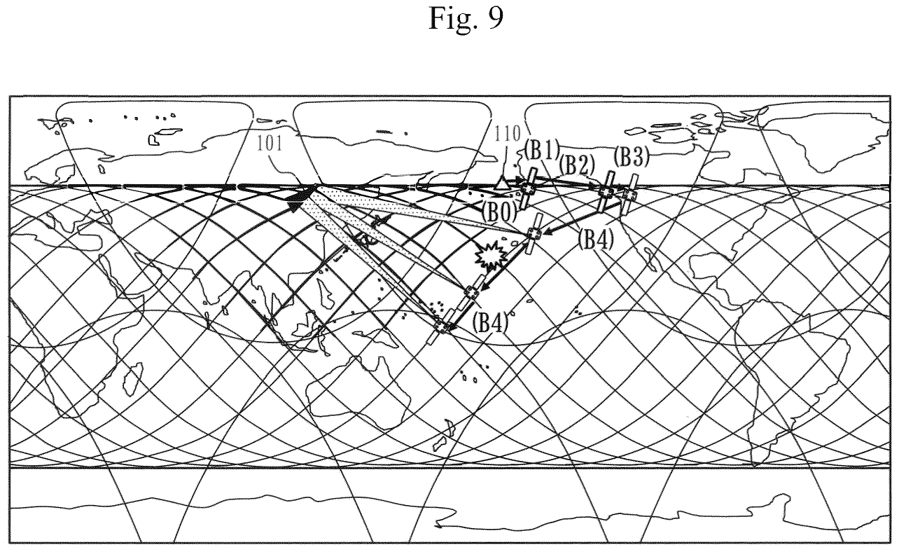

Based on FIG. 9, feature (3) of Embodiment 1 is described.

The flying object tracking system is formed of a satellite constellation and a ground system.

In the satellite constellation, each of multiple artificial satellites flies in an inclined orbit. Each of the multiple artificial satellites includes an infrared monitoring device, a first communication device, and a second communication device. The multiple artificial satellites form an annular communication network with the artificial satellites ahead and behind them on the same orbital plane.

The satellite constellation includes multiple orbital planes with the azimuth components of the normal vectors distributed in the longitude direction.

(B0) First, the ground system receives the time of launch TO of the flying object and the position coordinates of the launch point as flying object detection information.

The ground system derives the time Tn at which the flying object will arrive at the position coordinates (xn, yn, zn) of the predicted point of landing N of the flying object.

The ground system selects a fourth orbital plane (a monitoring orbital plane) that will pass above the position coordinates (xn, yn, zn) at time Tn.

Next, the ground system generates a track/monitor command to order satellites to point above the position coordinates of the launch point.

(B1, B2) The ground system transmits the track/monitor command ordering the artificial satellites on the fourth orbital plane to artificial satellites flying on a third orbital plane (a via-orbital plane) that passes above the ground system at the time T1 when transmission preparation for the command is completed.

The ground system then shares information with a third annular communication network formed by the third orbital plane.

(B3) The artificial satellites on the third orbital plane and the artificial satellites on the fourth orbital plane connect the third annular communication network with a fourth annular communication network by performing communication between the satellites when they pass near a closest approach point in their respective orbits. Two closest approach points are formed on the intersection line of orbital planes.

(B4) The track/monitor command to the artificial satellites on the fourth orbital plane is transmitted to the satellite group on the fourth orbital plane by way of the third annular communication network and the fourth annular communication network.

Launch detection information for a flying object may be acquired by a satellite on its own or launch detection information for the flying object may trigger the tracking of the flying object by the flying object tracking system. When the satellite performs launch detection on its own, it may be equipped with an infrared monitoring device pointed to the ground surface, and high-temperature smoke called plume may be detected upon launch of a flying object. To extensively detect the launch of a flying object launched from a mid-latitude zone, however, an increased number of satellites is required.

In launch detection, infrared monitoring is possible even with geostationary satellites because high-temperature smoke diffuses over a large area. Accordingly, it is rational to acquire launch detection information for the flying object from a geostationary satellite and the information may trigger tracking. A geostationary satellite is an artificial satellite that flies in a geostationary orbit.

It should be noted that the fourth orbital plane, which passes above the position coordinates (xn, yn, zn) at time Tn, passes in a longitude zone different from (xn, yn, zn) at time T1.

An orbital plane with an inclined orbit rotates slightly in the longitude direction without synchronizing with the rotation of the earth. Accordingly, the fourth orbital plane, which will pass above the predicted point of landing at future time Tn, would pass on the east side relative to the predicted landing position coordinates (xn, yn, zn) on the earth at time T1. However, by performing monitoring while waiting for the flying object with this orbital plane, proper monitoring of progress up to the arrival of the flying object is possible. Thus, before the predicted time of landing, accurate monitoring in a nearest condition is possible.

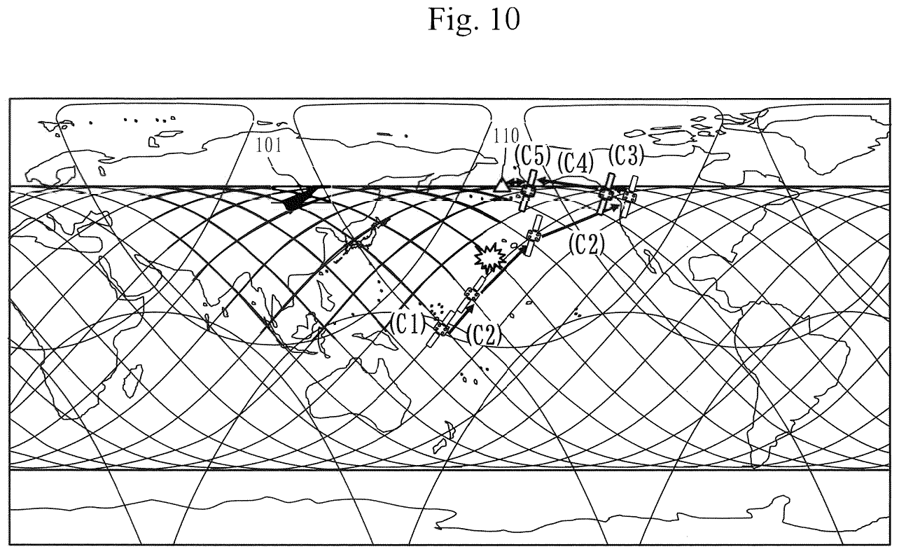

Based on FIG. 10, feature (4) of Embodiment 1 is described.

(C1, C2) The satellite group on the fourth orbital plane shares the flying object information acquired by an infrared monitoring device at time T2 within the fourth annular communication network.

(C3 to C5) A fifth orbital plane (a via-orbital plane) passes above the ground system at or after time T2.

The artificial satellites on the fourth orbital plane and the artificial satellites on the fifth orbital plane connect the fourth annular communication network with a fifth annular communication network by performing communication between the satellites when they pass near a closest approach point in their respective orbits. Two closest approach points are formed on the intersection line of orbital planes.

The artificial satellites on the fourth orbital plane and the artificial satellites on the fifth orbital plane transmit flying object information to the ground system by way of the fourth annular communication network and the fifth annular communication network.

Feature (5) of Embodiment 1 is described.

The ground system derives update information for the predicted flight path of the flying object based on flying object information that is acquired by the satellite group on the fourth orbital plane at or after time T2.

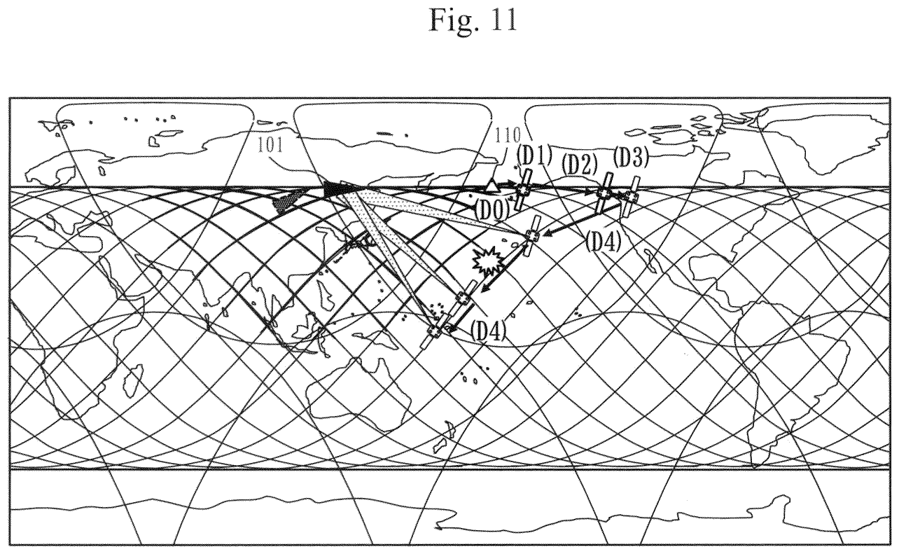

Based on FIG. 11, feature (6) of Embodiment 1 is described.

(D0) The ground system generates a track/monitor command for the artificial satellites on the fourth orbital plane (a tracking orbital plane). This track/monitor command orders them to point to the predicted flight position coordinates of the flying object at time T3.

(D1, D2) The ground system transmits the track/monitor command ordering the artificial satellites on the fourth orbital plane to artificial satellites flying on a sixth orbital plane (a via-orbital plane) that passes above the ground system at the time T4 when transmission preparation for the command is completed. The ground system then shares information with a sixth annular communication network formed by the sixth orbital plane.

(D3) The artificial satellites on the sixth orbital plane and the artificial satellites on the fourth orbital plane connect the sixth annular communication network with the fourth annular communication network by performing communication between the satellites when they pass near a closest approach point in their respective orbits. Two closest approach points are formed on the intersection line of orbital planes.

(D4) The artificial satellites on the sixth orbital plane and the artificial satellites on the fourth orbital plane transmit a track/monitor command ordering the artificial satellites on the fourth orbital plane to the satellite group on the fourth orbital plane by way of the sixth annular communication network and the fourth annular communication network.

Feature (7) of Embodiment 1 is described.

After the flying object tracking method is repeated, the ground system updates the landing prediction information and derives a predicted time of landing Tn2 and position coordinates (xn2, yn2, zn2) corresponding to a predicted point of landing N2.

Feature (8) of Embodiment 1 is described.

The ground system generates flying object information including updated values of landing prediction information for the countering assets (120).

At time T5 when transmission preparation is completed, the ground system transmits the flying object information to artificial satellites flying on a seventh orbital plane (a via-orbital plane) that passes above the ground system. Then, the ground system shares information with a seventh annular communication network formed on the seventh orbital plane.

An eighth orbital plane (a tracking orbital plane) passes above the position coordinates (xn2, yn2, zn2) of the predicted point of landing N2 at time Tn2.

The artificial satellites on the seventh orbital plane and the artificial satellites on the eighth orbital plane connect the seventh annular communication network with an eighth annular communication network by performing communication between the satellites when they pass near a closest approach point in their respective orbits. Two closest approach points are formed on the intersection line of orbital planes.

Then, the artificial satellites on the seventh orbital plane and the artificial satellites on the eighth orbital plane transmit the flying object information to the countering assets.

Feature (9) of Embodiment 1 is described.

The satellite constellation is made up of 12 or more orbital planes.

The satellite constellation includes 15 or more artificial satellites per orbital plane.

Feature (10) of Embodiment 1 is described.

The infrared monitoring device is pointed to the limb of the earth.

### Summarization of Embodiment 1

For tracking and monitoring of a flying object with a low-orbit satellite constellation, a predicted time of landing is derived using launch detection information and a flight path model. The flight path model is prestored in a server. Then, at the predicted time of landing, limb monitoring for a flying object is performed from the orbital plane passing over the predicted landing position coordinates. After that, the position coordinates of the flying object are derived by aerial triangulation and flying object information is transmitted to countering assets. For sharing of information between two orbital planes, inter-satellite communication is implemented at two intersection points formed on the intersection line of the two orbital planes or in the vicinity of the closest approach points. One of the orbital planes is an orbital plane that passes above the ground system. The other orbital plane is an orbital plane that passes above the predicted landing position coordinates at the predicted time of landing. In this manner, rapid and easy exchange of information between orbits is achieved.

### Effects of Embodiment 1

With the flying positions of artificial satellites overhead changing with time without synchronization between the rotation of the earth and the rotations of the orbital planes, flying object information can be transmitted reliably and rapidly via a satellite constellation which centralizes monitoring and communications.

By deriving the predicted time of landing and the position coordinates at that time utilizing a flight path model and waiting for the flying object with an orbital plane that will pass above the position in future, position coordinate measurements via limb monitoring becomes possible and rapid transmission of flying object information to countering assets is enabled.

Stereoscopy from multiple satellites in inclined orbits improves the accuracy of derivation of flight position coordinates.

Through annular communication networks and communications near intersection points, flying object information can be quickly and easily transmitted.

### Additional Description on Embodiment 1

### Additional Description of Background

There are flying object countering systems that are predicated on ballistic flight of a flying object. In such a flying object countering system, smoke (plume) at the time of launch is detected by an infrared observation device mounted on a geostationary satellite. Then, landing prediction is made based on movement information in an early phase of flight and countering by a countering system is done.

Smoke at the time of launch causes extremely hot gas to be spread over a wide area. Thus, detection is possible with monitoring from a geostationary orbit.

However, flying objects that intermittently inject during flight to change their flight path have emerged, posing a new threat. For tracking of a flying object with injection stopped, infrared monitoring of high resolution and high sensitivity is required in order to detect an increased temperature of the flying object body. Accordingly, such a new type of flying objects cannot be handled by conventional monitoring with geostationary satellites.

There has been an ongoing study of a system to monitor a flying object from a much closer distance than that from a geostationary orbit using a satellite constellation of LEO satellites. There is also a demand for a mechanism to perform continuous monitoring via an LEO satellite constellation and to deliver information to countering assets immediately after detection of the launch of a flying object.

### ***Additional Description of Challenges***

### <Challenges of Low-Orbit Satellite Constellation>

Continuous monitoring with LEO satellites and maintaining of communication lines requires a vast number of satellites. Further, while a geostationary satellite appears to be substantially fixed relative to an earth fixed coordinate system, an LEO satellite changes its flight position with time. Thus, configurations of infrared surveillance satellites and communication satellite groups as well as how data is transmitted pose challenges. An infrared surveillance satellite is a monitoring satellite equipped with an infrared monitoring device.

### <Challenges of Mesh Communication Networks>

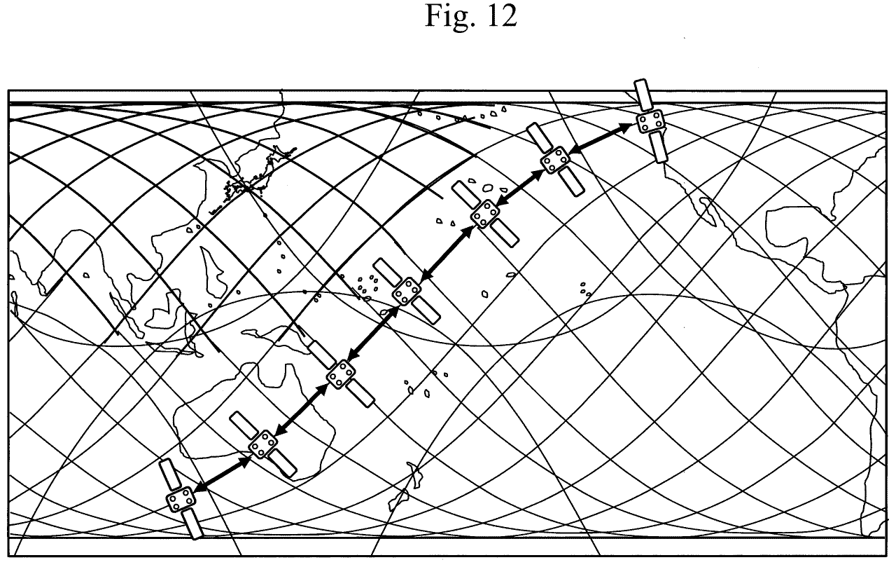

FIG. 12 shows how communication is performed between satellites ahead and behind each other on the same orbital plane.

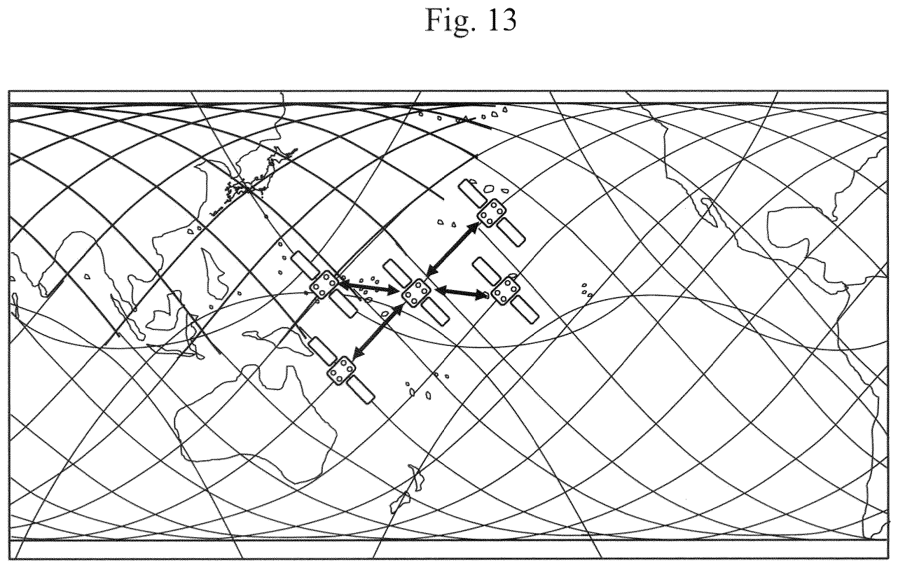

FIG. 13 shows how communication is performed between right and left satellites in adjacent orbits.

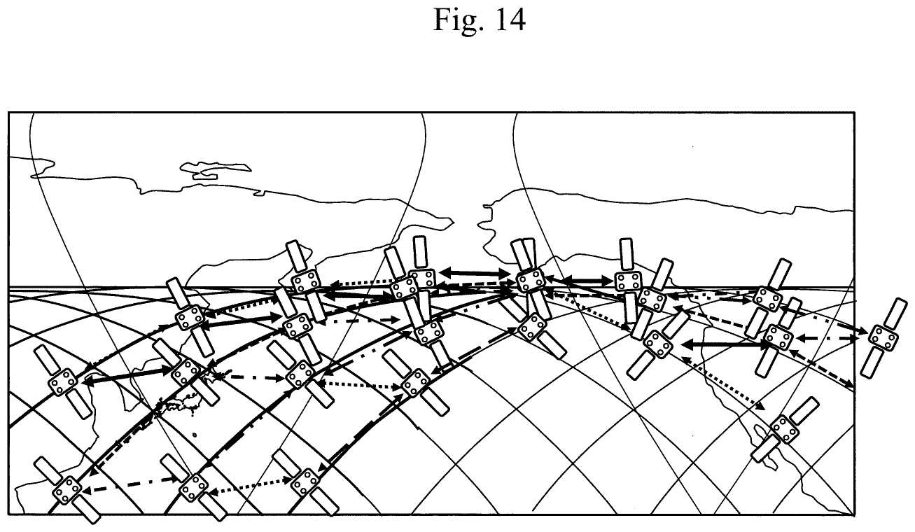

FIG. 14 illustrates switching of right and left sides between artificial satellites in adjacent orbits at southern and northern edges.

A concept of low-orbit satellite constellation has recently emerged. According to the concept, an annular communication network is formed by communications of artificial satellites with the artificial satellites ahead and behind them on the same orbital plane, and further a mesh communication network is formed by communications of lateral artificial satellites on adjacent orbits with each other. At southern and northern edges of the orbital planes, however, right and left sides are switched between the adjacent orbits. Accordingly, in the communications between right and left artificial satellites in the adjacent orbits, interruption of communication occurs twice or more in each revolution and re-establishment of a communication line is required correspondingly, leading to complicated operations.

Additionally, a transmission scheme of flying object information via a mesh communication network requires selecting artificial satellites on a path on which information exchange will be performed, setting the times at which information exchange will be performed, and searching for a shortest communication route. Thus, its operations become complicated.

### <Challenges of Low-Orbit Satellites>

The orbital period of a geostationary satellites synchronizes with the rotation of the earth. This allows a ground system installed at a particular longitude to communicate with a certain geostationary satellite at all times. In contrast, the orbital period of a low-orbit satellites does not synchronize with the rotation of the earth; each individual low-orbit satellite passes over a ground facility installed at a particular longitude in a short time. So, for preparation of an environment in which continuous communication is available, coordination of many satellites is required.

### <Challenges of Non-Sun-Synchronous Orbits>

On the orbital plane of a sun synchronous satellite, the revolution period of the orbital plane relative to the earth is in synchronization with the revolution period of the earth with respect to the sun. Accordingly, for the orbital plane of a sun synchronous satellite, its normal vector makes one revolution around the earth per year in synchronization with the earth. Also, the incidence angle of sunlight relative to the orbital plane of a sun synchronous satellite remains substantially constant throughout the year. An artificial satellite that flies in the sun synchronous orbit of LST 12:00 will pass above any ground system installed in any country across the world at noon, or 12:00. LST is an abbreviation for Local Sun Time.

In contrast, for an orbit not in synchronization with the sun (a non-sun-synchronous orbit), the sun incidence angle with respect to its orbital plane changes with time. Thus, the time at which an artificial satellite flies above a ground system installed at a certain location will vary.

### <Challenges of Inclined Orbit>

Rotation of the orbital plane of an inclined orbit satellite is in synchronization with neither the rotation of the earth nor the revolution of the earth with respect to the sun. So, when the orbital plane of an inclined orbit satellite is seen from a ground system installed at a particular latitude and longitude, the longitude component of the normal vector relative to the orbital plane makes relative movement. This limits a time window in which the inclined orbit satellite passes above the ground system. Moreover, even if the orbital plane is at a position in which the orbital plane passes above the ground system, the artificial satellite is not always flying above the ground system. Also, even if the orbital plane passes above the ground system and there is a time window in which the artificial satellite flies above the ground system, the time window changes.

### Additional Description of Solution

### <Tracking a Flying Object>

Embodiment 1 discloses a method of transmitting urgent flying object information. In this method, annular communication networks within orbital planes and inter-satellite communications at the time of passing near a closest approach point are used in an inclined orbit constellation. The inter-satellite communication is performed on the intersection line between orbital planes. Thus, exchange of flying object information between different orbits is achieved in near real time in a quick and simple operation scheme.

In near real time, time delay involved in information transmission and latency before artificial satellites can exchange information at an earliest timing are taken into consideration.

### <Aggregation of Launch Detection Information>

As smoke at increased temperature spreads over a wide area upon launch of a flying object, detection information acquired by geostationary satellites may be obtained for detection of the launch of a flying object. Also, infrared monitoring devices pointed to the ground surface may be provided in a low-orbit satellite constellation and information resulting from launch detection may be acquired.

<Continuous Communication Environment with a Ground System>

In order to transmit launch detection information to a ground system installed at a particular latitude and longitude, 15 or more artificial satellites fly on the same orbital plane in an inclined orbit satellite constellation and information transmission to the ground system is performed in near real time. For instance, at an orbit altitude of about 1000 kilometers, an artificial satellite would make one revolution around the earth in about 100 minutes. Then, in a case where an orbital plane passes above the ground system, a preceding artificial satellite flies above the ground system for several minutes and thereafter a following artificial satellite comes. That is, artificial satellites on the same orbital plane are always flying in the range of communication field of view of the ground system. If an annular communication network is formed within the same orbital plane, an artificial satellite communicating with the ground system can send and receive information from the other artificial satellites on the same orbital plane to and from the ground system on behalf of the artificial satellites on the same orbital plane.

Furthermore, the constellation includes 12 or more orbital planes with the longitude direction components of their normal vectors distributed. In the 12 orbital planes, the elongation of the longitude direction components of the normal vectors is 30 degrees, an angle equivalent to two hours of rotation of the earth. A communication field of view with the artificial satellites on the adjacent orbital plane on the east side is guaranteed by earth rotation effect when 15 or more artificial satellites perform communication with the ground system in sequence while making one revolution in about 100 minutes on each of the adjacent orbital planes. Accordingly, if 15 or more artificial satellites are flying on each of 12 or more orbital planes, continuous communication with a ground system installed at a particular latitude and longitude is possible.

It goes without saying that the number of orbital planes required and the number of satellites on the same orbital plane vary depending on the latitude of the ground system, the altitudes of the artificial satellites, the orbital inclinations of the artificial satellites, and communication traffic.

For example, if the orbital inclination is smaller than the latitude of the ground system, the southern and northern edges of the orbital plane do not reach above the ground system. Thus, this has to be addressed by modifying the communication field of view. Also, increased numbers of orbital planes and satellites will be required.

### <Transmission of Launch Detection Information to a Ground System>

In order for a certain artificial satellite in an inclined orbit satellite constellation to detect the launch of a flying object and transmit launch information for the flying object to a ground system at a particular latitude and longitude, it is necessary to transmit flying object information from an orbital plane (1) on which the artificial satellite that has detected the launch flies to an orbital plane (2) that passes above the ground system. Embodiment 1 focuses on the fact that there are two intersection points at the same orbit altitude on the intersection line of the orbital plane (1) and the orbital plane (2). Then, by performing proximity communication between artificial satellites passing near the intersection points, flying object information is transmitted between the orbital planes.

Information from the artificial satellite that has detected the launch of the flying object is transmitted through the annular communication network of the orbital plane (1) to an artificial satellite on the orbital plane (1) that passes near an intersection point with the orbital plane (2). Then, the flying object information received by an artificial satellite on the orbital plane (2) at the intersection point is transmitted to the ground system by way of the annular communication network of the orbital plane (2).

### <Predicting a Flying Object's Landing Position>

The ground system is equipped with a flying object path model in advance. Then, multiple candidate landing points are extracted, with the start point being the position coordinates of the launch site contained in launch information for the flying object. A candidate landing point is a location where a landing is expected (for example, a major city). Furthermore, a predicted time of landing T1 corresponding to the time of launch TO is derived, with the endpoint being the position coordinates of each candidate point.

### <Processing at the Ground System>

The ground system obtains the time of launch TO and the position coordinates of the launch point (xt0, yt0, zt0) in an earth fixed coordinate system as launch detection information.

The ground system extracts the position coordinates of candidate cities (A, B, C, . . . , N) as candidate landing points from a database stored in a server.

The ground system uses the flight path model to derive an expected time of arrival Tal at a candidate city A.

The ground system selects an orbital plane [1] which passes through the position coordinates (xa, ya, za) of the candidate city A at time Tal.

Similarly, the ground system selects an orbital plane [2] which passes through the position coordinates (xb, yb, zb) of candidate city B at time Tb1, and selects an orbital plane [3] which passes through the position coordinates (xc, yc, zc) of candidate city C at time Tc1. The ground system also selects an orbital plane [N] which passes through the position coordinates (xn, yn, zn) of candidate city N at time Tn1.

The same orbital plane may be overlapping among the orbital planes [1] to [N]

### <Monitoring Against Deep Space Background by Limb Monitoring>

As hot air spreads with smoke upon launch of a flying object, monitoring of the flying object is easy to perform at the time of launch. In a post-boost phase after injection is stopped, however, the solid angle of the flying object body as seen from a monitoring satellite is small and a rise in the temperature of the flying object body is not as prominent as with smoke. So, there is a concern that identification of a flying object is impossible if land area information is contained in background. Hence, limb observation pointed to the limb of the earth is performed. In the motoring approach called limb observation, a flying object body at increased temperature is monitored against deep space as background. This prevents the flying object from being buried in noise, allowing for monitoring of the flying object.

### <Track Command for Predicted Landing Position>

Command information for limb monitoring pointed above the position coordinates (xt0, yt0, zt0) at which the launch was detected is transmitted to the artificial satellites on the orbital planes [1] to [N].

The orbital plane that passes above the ground system at the time of transmission is referred to as orbital plane [0]. Exchange of information between the orbital plane [0] and the orbital planes [1] to [N], which are different from each other, is performed via proximity communication between artificial satellites passing near an intersection point of orbital planes.

### <Limb Monitoring on Each Orbital Plane>

Limb monitoring is performed pointed to the position coordinates (xt0, yt0, zt0) from the artificial satellite groups flying on the orbital planes [1] to [N].

### <Update of Monitoring Direction Over Time>

In the ground system, estimated position coordinates (t1, xt1, yt1, zt1) of the flying object at T1 upon elapse of time are derived using the flight path model.

Similarly, position coordinates (tn, xtn, ytn, ztn) are derived using the flight path model. Then, limb monitoring is performed pointed to the position coordinates for each time from the artificial satellite groups flying on the orbital planes [1] to [N].

### <Predicting and Updating the Flight Path>

In the ground system, flying object information resulting from detection of a hot object by multiple monitoring satellites is analyzed and temporal change in positional information is analyzed. In this manner, the flying object can be tracked and prediction of its flight path becomes possible.

Even if the flying object intermittently re-injects during flight to change its direction of travel, the flying object can be handled by continuously acquiring time-series information.

### <Sharing of Tracking Information>

An artificial satellite that has detected a bright point shares flying object information with an artificial satellite on the same orbital plane by using an annular communication network.

An artificial satellite passing near an intersection point with another orbital plane transmits the flying object information to an artificial satellite on the other orbital plane.

On the other orbital plane, the flying object information is shared among the artificial satellites on the other orbital plane using an annular communication network.

### <Deriving Flying Object Position Coordinates>

Multiple artificial satellites derive the actual position coordinates of the flying object using the line of sight vector of the detected bright point and the position coordinates of the satellites according to the principle of aerial triangulation.

### <Update of Landing Prediction Information>

By updating landing prediction information based on the actual position coordinates, a final expected landing city can be determined by repeating addition of candidate cities and update of the actual position coordinates.

### <Transmitting Flying Object Information to Countering Assets>

Flying object information is transmitted to countering assets.

A variety of countering assets exist, such as aircrafts deployed in air, ships deployed in sea, vehicles deployed on land, or ground-based facilities. There are also means to transmit information directly to individual assets. However, when a system not specifically designed for security is used as a satellite information transmission system, position information for individual assets cannot be disclosed in some cases such as due to security limitation. In those cases, it is rational to centralize flying object information at a countering ground center that delivers commands to countering assets and to give commands to countering assets from the countering ground center.

In the United States, communications with countering assets can be performed using a dedicated line called Link16. Also, a moving vehicle such as a ship can serve as a countering ground center.

### Additional Description on Effects

### <Proximity Communication at Orbital Plane Intersection Point>

In communication between adjacent orbits, communication over a long distance is required such as above the equator. Thus, a large-diameter antenna with a drive mechanism is necessary as a communication device. For optical communication, accurate optical axis alignment is required for establishment of communication lines.

In contrast, proximity communication can be implemented with a non-directional antenna or a fixed antenna. Thus, system costs can be low. Also, need of complicated operations for establishing communication lines is eliminated.

On two orbits with different normal vectors, there will always be two intersection points. By making use of this feature, communication across orbits needs to be performed only once. This eliminates the necessity of repeating communication between adjacent orbits a number of times, simplifying operations.

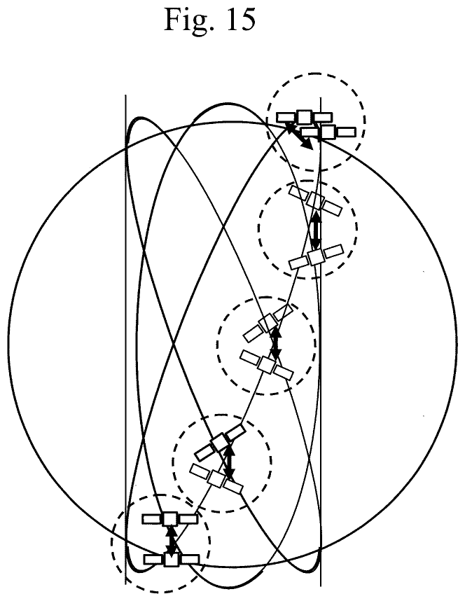

FIG. 15 shows how communication takes place between one orbital plane and all the other orbital planes.

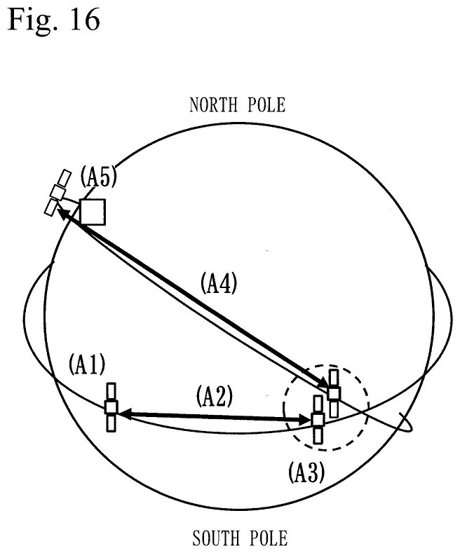

FIG. 16 shows a flow of communication from a satellite constellation to a ground system.

<Limb Monitoring from Inclined Orbits>

Monitoring pointed to the limb of the earth is called limb monitoring. Limb monitoring can monitor a flying object against space as background. Thus, the flying object body at increased temperature after injection ended can be monitored by an infrared monitoring device without being embedded in errors.

In an equatorial orbit, limb monitoring of mid-latitude zone can be performed at all times by a large number of artificial satellites that fly following one another in a row, even if the speed of rotation of the earth and the orbiting speed of the satellites are different.

In a satellite constellation in an equatorial orbit, limb monitoring of mid-latitude zone is possible only with the artificial satellites on a single orbital plane. However, the solid angle is limited in stereoscopy with multiple artificial satellites. Consequently, the accuracy of deriving the position coordinates of a flying object is low in the depth direction (that is, latitude direction) of the line of sight vector.

When the orbital inclination changes to 20 degrees, the latitude zone range covered by the limb monitoring varies. However, since the region under limb monitoring by individual satellites is toroidal-shaped, the mid-latitude zone can be monitored with line of sight vector components not only in the latitude direction but also in the longitude direction.

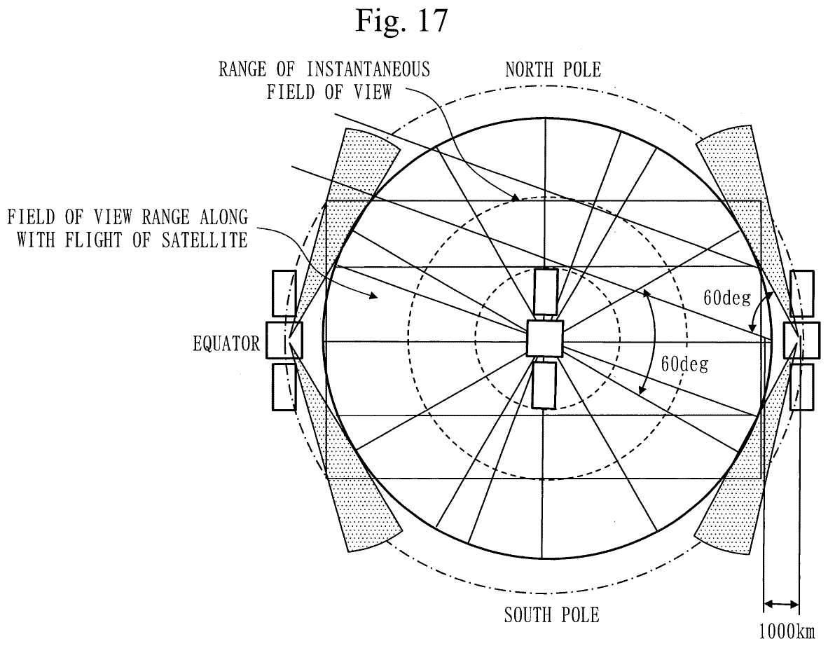

FIG. 17 shows field of view ranges of artificial satellites in an equatorial orbit.

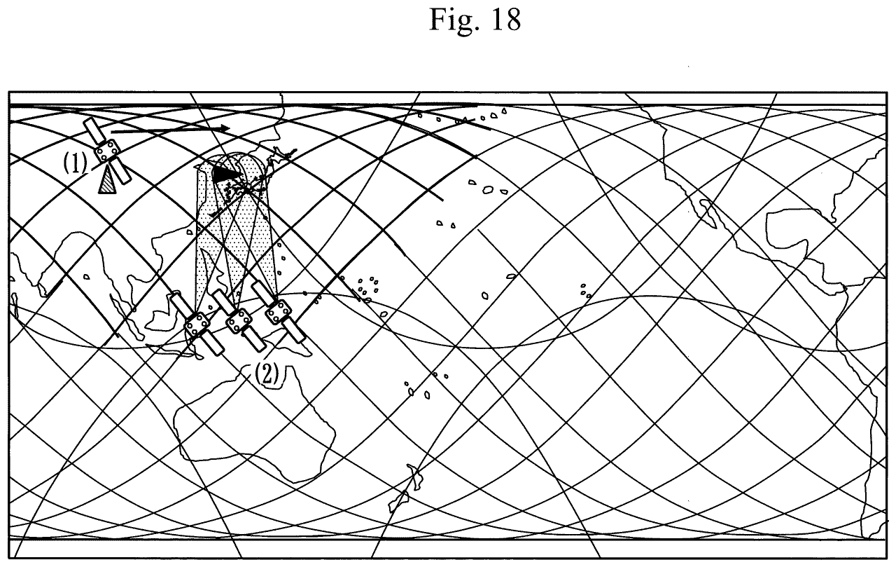

FIG. 18 shows (1) how launch detection is performed directly from above and (2) how limb observation is performed from approximately above the equator.

In Embodiment 1, the orbital planes of the satellite constellation in an equatorial orbit have orbital inclinations.

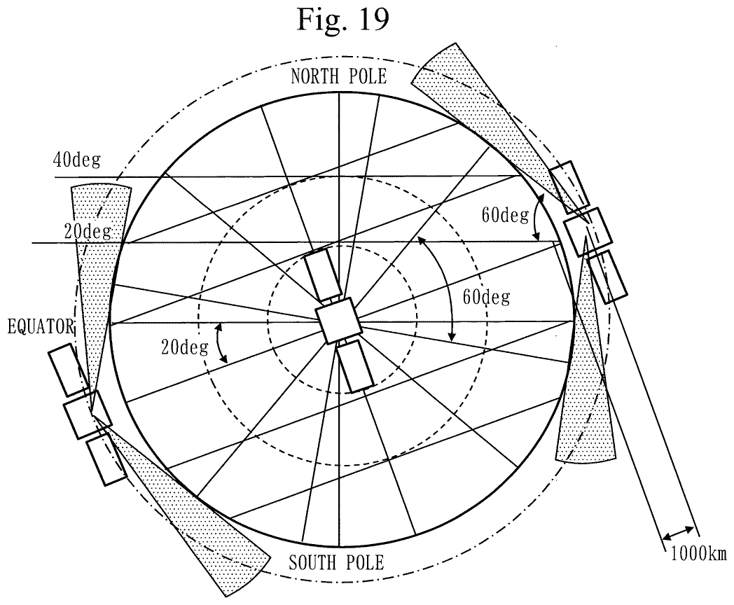

FIG. 19 shows field of view ranges of artificial satellites in an inclined orbit.

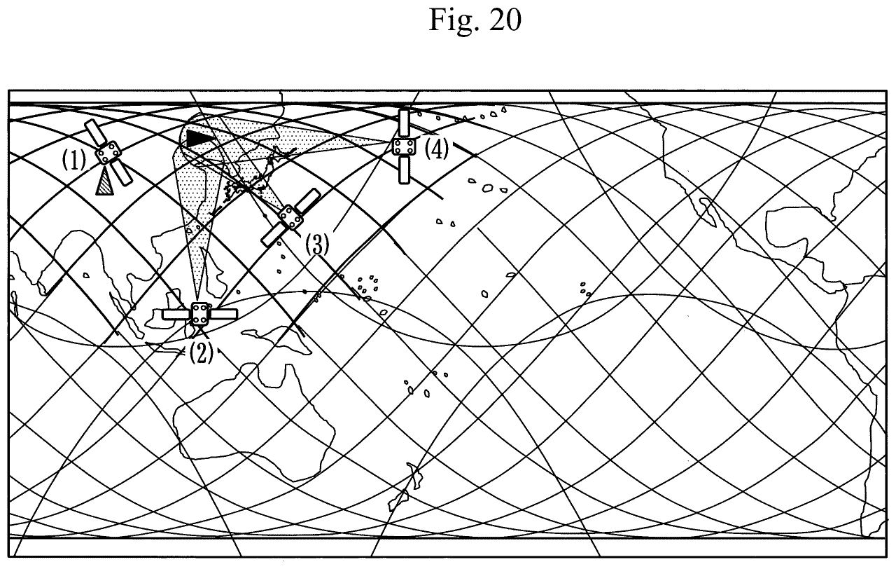

FIG. 20 shows (1) how launch detection is performed directly from above, and limb observation from (2) approximately above the equator, (3) a mid-latitude zone, and (4) near the northern edge of the orbital plane.

As a result, a wider solid angle of the line of sight vector is provided when a flying object is monitored from multiple artificial satellites. It in turn improves the accuracy of aerial triangulation in measurement of the position coordinates of the flying object.

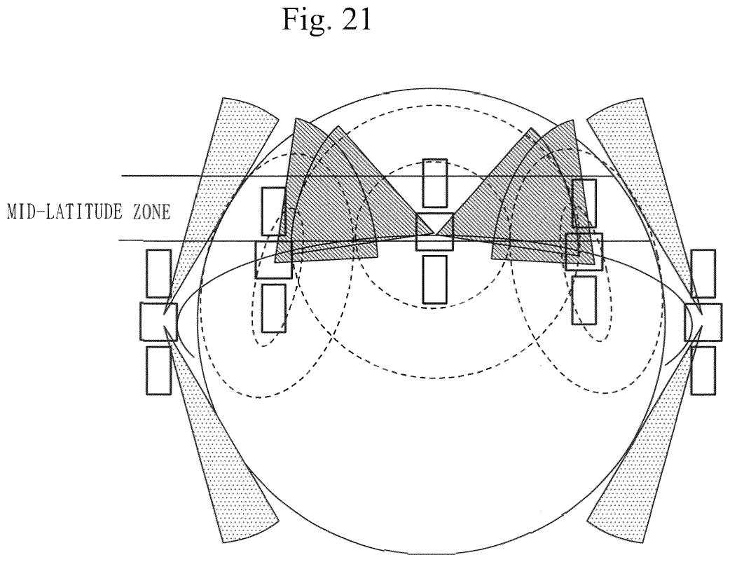

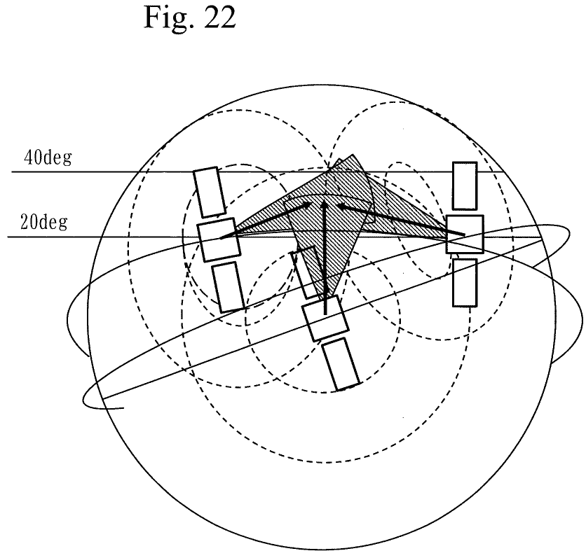

FIGS. 21 and 22 show how the solid angle is guaranteed in a mid-latitude zone.

For example, if the flying positions of artificial satellites are known in the earth fixed coordinate system WGS84, the position coordinates of the flying position of a flying object can be derived using WGS84. WGS84 is a coordinate system employed in GPS and quasi-zenith positioning satellite systems.

When the number of satellites per orbital plane is 15 or higher and the number of orbital planes is 12 or higher, the number of artificial satellites that can simultaneously track a specific flying object is sufficient and there is a high probability of success in countering. Also, an increased number of flying objects can be tracked simultaneously.

Due to the effect of orbital inclination, a latitude zone that can be monitored by limb monitoring becomes larger. Thus, a range monitorable as the launch point of a flying object can be expanded.

<Limb Monitoring of a Predicted Landing Position from Orbital Planes>

The fourth orbital plane passes above the position coordinates (xn, yn, zn) at the predicted time of landing Tn and passes through a longitude zone different from the position coordinates (xn, yn, zn) at time T1.

An orbital plane with an inclined orbit rotates slightly in the longitude direction without synchronizing with the rotation of the earth. Accordingly, the fourth orbital plane will pass above the predicted point of landing at a future time Tn and pass on the east side relative to the predicted landing position coordinates (xn, yn, zn) on the earth at time T1. By performing monitoring while waiting for the flying object with this orbital plane, proper monitoring of progress up to the arrival of the flying object is possible. Then, before the predicted time of landing, accurate monitoring in a nearest condition is possible.

When monitoring is performed from an artificial satellite group flying in an inclined orbit from southwest to northeast in order to monitor a flying object flying from west to east, it provides multiple pieces of monitoring information with the solid angles of the line of sight vectors distributed. This enables accurate derivation of the flight position coordinates. Additionally, because the flying object will approach the predicted landing position, higher luminance is acquired as flying object information in monitoring with infrared monitoring devices, allowing for improved positional accuracy.

When infrared monitoring is performed assuming multiple predicted points of landing beforehand, orbital planes on which flying object information is not acquired can be excluded from the predicted points of landing. Thus, the predicted flight path can be narrowed down over time.

Embodiment 1 is illustrative of a preferred embodiment and is not intended to limit the technical scope of the present disclosure. Embodiment 1 may be partially practiced or may be practiced in combination with other embodiments.

### REFERENCE SIGNS LIST

100: flying object tracking system; 101: flying object; 110: ground system; 111: satellite communication device; 112: server device; 113: ground communication device; 119: flight path model; 120: countering asset; 200: satellite constellation; 210: artificial satellite group; 220: artificial satellite; 221: infrared monitoring device; 222: in-orbit communication device; 223: inter-orbit communication device; 224:

space-ground communication device; 225: line-of-sight controller

1. A flying object tracking method for a flying object tracking system comprising:
a ground system and a satellite constellation, wherein
the satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane,
a detecting satellite detects a launch of a flying object and transmits, via communications with the artificial satellites ahead and behind it on a detecting orbital plane, launch detection information to each of artificial satellites on the detecting orbital plane, wherein the detecting satellite is one of the artificial satellites in the satellite constellation and the detecting orbital plane is the own orbital plane,
when a source satellite flies on the detecting orbital plane in a communication range with a via-orbital plane that passes above the ground system, the source satellite transmits the launch detection information to a target satellite, wherein the source satellite is one of the artificial satellites on the detecting orbital plane and the target satellite is one of the artificial satellites on the via-orbital plane,
the target satellite transmits the launch detection information to each of the artificial satellites on the via-orbital plane via communications with the artificial satellites ahead and behind it on the via-orbital plane, and
an air-to-ground satellite transmits the launch detection information to the ground system, wherein the air-to-ground satellite is one of the artificial satellites on the via-orbital plane.

2. A flying object tracking method for a flying object tracking system comprising:
a ground system and a satellite constellation to detect a launch of a flying object, wherein
the satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane, and
the ground system
receives launch detection information indicating a time of launch of the flying object and coordinate values of a launch point of the flying object from the satellite constellation, and
derives a predicted time of landing of the flying object and coordinate values of a predicted point of landing of the flying object based on the launch detection information and on a flight path model indicating a relationship between flight direction, time-series flight distance, and time-series flight altitude.

3. A flying object tracking method for a flying object tracking system comprising:
a ground system and a satellite constellation to detect a launch of a flying object, wherein
the satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane,
the ground system receives launch detection information indicating a time of launch of the flying object and coordinate values of a launch point of the flying object from the satellite constellation, derives a predicted time of landing of the flying object and coordinate values of a predicted point of landing of the flying object, generates a monitor command for each of artificial satellites on a monitoring orbital plane that will pass above the predicted point of landing at the predicted time of landing, and transmits the monitor command to an air-to-ground satellite, wherein the air-to-ground satellite is one of the artificial satellites on a via-orbital plane that passes above the ground system at a time when transmission preparation for the monitor command is completed,
the air-to-ground satellite transmits the monitor command to each of artificial satellites on the via-orbital plane via communications with the artificial satellites ahead and behind it on the via-orbital plane,
when a source satellite flies on the via-orbital plane in a communication range with the monitoring orbital plane, the source satellite transmits the monitor command to a target satellite, wherein the source satellite is one of the artificial satellites on the via-orbital plane and the target satellite is one of the artificial satellites on the monitoring orbital plane, and
the target satellite transmits the monitor command to each of the artificial satellites on the monitoring orbital plane via communications with the artificial satellites ahead and behind it on the monitoring orbital plane.

4. A flying object tracking method for a flying object tracking system comprising:
a ground system and a satellite constellation, wherein
the satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane,
a monitoring satellite monitors a flying object and transmits, via communications with the artificial satellites ahead and behind it on a monitoring orbital plane, flying object information to each of artificial satellites on the monitoring orbital plane, wherein the monitoring satellite is one of the artificial satellites in the satellite constellation and the monitoring orbital plane is the own orbital plane,
when a source satellite flies on the monitoring orbital plane in a communication range with a via-orbital plane that passes above the ground system, the source satellite transmits the flying object information to a target satellite, wherein the source satellite is one of the artificial satellites on the monitoring orbital plane and the target satellite is one of the artificial satellites on the via-orbital plane,
the target satellite transmits the flying object information to each of the artificial satellites on the via-orbital plane via communications with the artificial satellites ahead and behind it on the via-orbital plane, and
an air-to-ground satellite transmits the flying object information to the ground system, wherein the air-to-ground satellite is one of the artificial satellites on the via-orbital plane.

5. A flying object tracking method for a flying object tracking system comprising:
a ground system and a satellite constellation to monitor a flying object, wherein
the satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane, and
the ground system
receives flying object information indicating a time of flight of the flying object and coordinate values of a flight point of the flying object from the satellite constellation, and
derives a predicted flight path of the flying object based on the flying object information.

6. The flying object tracking method according to claim 5, wherein
the ground system derives a predicted time of landing of the flying object and a predicted point of landing of the flying object based on the flying object information and on a flight path model indicating a relationship between flight direction, time-series flight distance, and time-series flight altitude.

7. A flying object tracking method for a flying object tracking system comprising:
a ground system and a satellite constellation to monitor a flying object, wherein
the satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane,
the ground system receives flying object information indicating a time of flight of the flying object and coordinate values of a flight point of the flying object from the satellite constellation, derives a predicted flight path of the flying object, generates a track command for a tracking satellite, wherein the tracking satellite is an artificial satellite on a tracking orbital plane that will pass above a predicted point of landing of the flying object at a predicted time of landing of the flying object, and transmits the track command to an air-to-ground satellite, wherein the air-to-ground satellite is one of the artificial satellites on a via-orbital plane that passes above the ground system at a time when transmission preparation for the track command is completed,
the air-to-ground satellite transmits the track command to each of artificial satellites on the via-orbital plane via communications with the artificial satellites ahead and behind it on the via-orbital plane,
when a source satellite flies on the via-orbital plane in a communication range with the tracking orbital plane, the source satellite transmits the track command to a target satellite, wherein the source satellite is one of the artificial satellites on the via-orbital plane and the target satellite is one of the artificial satellites on the tracking orbital plane, and
the target satellite transmits the track command to each of the artificial satellites on the tracking orbital plane via communications with the artificial satellites ahead and behind it on the tracking orbital plane.

8. The flying object tracking method according to claim 7, wherein
the ground system derives the predicted time of landing and the predicted point of landing based on the flying object information and on a flight path model indicating a relationship between flight direction, time-series flight distance, and time-series flight altitude.

9. A flying object tracking method for a flying object tracking system comprising:
a ground system and a satellite constellation to monitor a flying object, wherein
the satellite constellation includes a plurality of artificial satellite groups flying on different orbital planes from each other, and forms a plurality of orbital planes with azimuth components of normal vectors being distributed in a longitude direction relative to each other,
each of the artificial satellite groups is made up of a plurality of artificial satellites that fly in an inclined orbit of an own orbital plane,
the ground system receives flying object information indicating a time of flight of the flying object and coordinate values of a flight point of the flying object from the satellite constellation, derives a predicted flight path of the flying object, selects a tracking orbital plane that will pass above a predicted point of landing of the flying object at a predicted time of landing of the flying object, and transmits the flying object information to an air-to-ground satellite, wherein the air-to-ground satellite is one of the artificial satellites on a via-orbital plane that passes above the ground system at a time when transmission preparation for the flying object information is completed,
the air-to-ground satellite transmits the flying object information to each of artificial satellites on the via-orbital plane via communications with the artificial satellites ahead and behind it on the via-orbital plane,
when a source satellite flies on the via-orbital plane in a communication range with the tracking orbital plane, the source satellite transmits the flying object information to a target satellite, wherein the source satellite is one of the artificial satellites on the via-orbital plane and the target satellite is one of the artificial satellites on the tracking orbital plane,
the target satellite transmits the flying object information to each of the artificial satellites on the tracking orbital plane via communications with the artificial satellites ahead and behind it on the tracking orbital plane, and
at least any of the artificial satellites on the tracking orbital plane transmits the flying object information to a countering asset.

10. The flying object tracking method according to claim 1, wherein
the satellite constellation includes 12 or more of the artificial satellite groups and forms 12 or more orbital planes, and
each of the artificial satellite groups is made up of 15 or more of the artificial satellites.

11. The flying object tracking method according to claim 1, wherein
each of the artificial satellites includes an infrared monitoring device pointed to a limb of the earth.

12. A flying object tracking system that performs the flying object tracking method according to claim 1.

13. A satellite constellation for use with the flying object tracking method according to claim 1.

14. A ground system for use with the flying object tracking method according to claim 1.
